(19) United States
(12) Patent Application Publication
(10) Pub. No.: US 2026/0099708 A1
(43) Pub. Date: Apr. 9, 2026

(54) BIG DATA INTELLIGENT SELECTION DESIGN METHOD FOR ROCKBURST-PREVENTION HYDRAULIC SUPPORTS IN ROCKBURST ROADWAYS

(71) Applicants: INNER MONGOLIA YITAI GUANGLIAN COAL CHEMICAL CO., LTD, Ordos City (CN); LIAONING UNIVERSITY, Shenyang (CN)

(72) Inventors: Yishan PAN, Shenyang (CN); Like ZHAO, Ordos City (CN); Lianpeng DAI, Shenyang (CN); Xueqi ZHANG, Ordos City (CN); Hao LUO, Shenyang (CN); Hongbin LI, Ordos City (CN)

(21) Appl. No.: 19/348,119

(22) Filed: Oct. 2, 2025

(30) Foreign Application Priority Data
Oct. 9, 2024 (CN) 202411399258.3

(51) Int. Cl. G06N 3/08

(52) U.S. Cl. CPC G06N 3/08

(57) ABSTRACT

The present invention provides a big data intelligent selection design method for rockburst-prevention hydraulic supports in rockburst roadways. In the method, firstly, data on geological conditions, rock mechanical properties, mine face layout, as well as usage performance and maintenance records of previous rockburst-prevention hydraulic supports is collected from different mining areas and historical records. Then, a machine learning method and a statistical analysis method are used to identify key factors affecting the performance of the rockburst-prevention hydraulic supports from an integrated dataset, thereby providing an intelligent rockburst-prevention hydraulic support selection system. The present invention can improve the selection accuracy and efficiency of the rockburst-prevention hydraulic supports and ensure safety. Through in-depth analysis of a large amount of geological data, mine face conditions, and historical rockburst-prevention hydraulic support usage, the most suitable rockburst-prevention hydraulic support selection suggestion is provided for roadways.

### BACKGROUND OF THE INVENTION

### Field of the Invention

The present invention relates to the technical field of mine big data, and in particular to a big data intelligent selection design method for rockburst-prevention hydraulic supports in rockburst roadways.

### The Prior Arts

Coal mine rockburst is a dynamic phenomenon where highly-stressed coal rock masses release energy instantaneously, thereby often causing significant impact destroy to surrounding rocks. In China, over 90% of rockburst happens in roadways. A rockburst-prevention hydraulic support apparatus in roadways serves as a last prevention line for preventing rockbursts. Selection design of a rockburst-prevention hydraulic support has significant impact on effectiveness in resisting rockburst damage.

Currently, primary selection design methods for rockburst-prevention hydraulic supports in rockburst face mining roadways include analytical theoretical analysis, experimental simulation, numerical calculation analysis, empirical formulas, etc., but still have the following problems:
(1) During numerical calculations, complex geological conditions often need to be simplified for the convenience of calculation. This simplification may omit key factors such as stratum heterogeneity and impact of joints and fractures, thereby leading to discrepancies between simulation results and actual conditions;
(2) Testing prototypes for laboratory testing are costly, making it difficult to simulate comprehensive and accurate geological information and geomechanical processes thereof; and
(3) Empirical formulas are generally derived from field experience, but lack universality for engineering projects under extreme conditions, and are difficult to develop and update within a specific cycle.

With vigorous advancement of intelligent mine construction in China, the question of “How to achieve intelligent, safe, and highly-efficient mining of rockburst coal seams?” became the only problem in the field of energy and mining engineering to be included in the list of the 2023 Top Ten Industrial Technology Issues released by the China Association for Science and Technology's (CAST) in 2023. Therefore, how to establish a big data intelligent selection design method is of great significance for the research and development of intelligent technology and equipment for rockburst prevention and control of coal mines.

### SUMMARY OF THE INVENTION

In view of defects in the prior art, the present invention provides a big data intelligent selection design method for rockburst-prevention hydraulic supports in rockburst roadways. Based on a deep analysis of the historical usage of existing roadway rockburst-prevention hydraulic supports, by providing corresponding geological conditions and parameters during a mining process, a big data system is used to provide a reasonable and safe selection method for rockburst-prevention hydraulic supports, thereby providing a scientific basis for the selection design of rockburst-prevention hydraulic supports in rockburst roadways.

The big data intelligent selection design method for rockburst-prevention hydraulic supports in rockburst roadways includes the following steps.
Step 1: performing data collection.
Step 1.1: establishing a table of geomechanical characterization parameters of the rockburst mining face.

The geomechanical characterization parameters include geological factor data and mining technical factor data, the geological factor data includes the following data: a uniaxial compressive strength σ_{c} of coal rocks, a bursting tendency index K of the coal rocks, an elastic modulus E of the coal rocks, an internal friction angle φ, a mean in-situ stress P₀, a mining depth h₀, and a historical record n of rockburst occurrences in coal seams at a same level, and the mining technical factor data includes the following data: a pressure relief degree P₁ of a protective seam, a horizontal distance h₁ from a coal pillar remained by mining the protective seam, a face length L₀, a width B of a sectional coal pillar, a thickness T of coal remained by mining, a roadway excavated towards a goaf, namely a distance h₂ between an excavating stopping position and the goaf, and a face advancing towards the goaf, namely a distance h₃ between a mining stopping line and the goaf.

Step 1.2: establishing a table of key parameters for selection of the rockburst-prevention hydraulic supports in the rockburst roadways.

The key parameters include the following data: an initial support force F_{c}, a working resistance R_{w} and a support intensity S.

Step 1.3: collecting the data.

Based on literature research via the Internet and field investigation analysis, M sets of information on the geomechanical characterization parameters of the rockburst mining face, as well as information on the key parameters of the rockburst-prevention hydraulic supports in the rockburst roadways are collected and analyzed.

Step 2: based on the neural network model, establishing a training sample for intelligent selection of the rockburst-prevention hydraulic supports.

Step 2.1: selecting the neural network model suitable for selection of the rockburst-prevention hydraulic supports, wherein the neural network model selects an MLP neural network model.

Step 2.2: defining a basic structure of the neural network model.

Step 2.2.1: determining an input layer and a size thereof.

Calculation is performed by using the geomechanical characterization parameters of the rockburst mining face as the input layer of the neural network model, expressed as:

$${X}_{m} = [ {σ}_{c} , K , E , φ , {P}_{0} , {h}_{0} , n , {P}_{1} , {h}_{1} , {L}_{0} , B , T , {h}_{2} , {h}_{3} ] , and$$

$${a}_{m}^{0} = {X}_{m} . \\ Where , {a}_{m}^{0}$$

represents the input layer of a m^{th} training sample of the neural network model; Xₘ represents a feature vector of the m^{th} training sample.

Step 2.2.2: determining a number of intermediate layers.

It is set that L layers in total exist in the neural network model, thus L−1 intermediate layers exist.

Step 2.2.3: determining a number of neurons in each layer, where

$${N}_{h}^{l} = \frac{M}{( α * ( {N}_{i} + {N}_{o} ) )} . Where {N}_{h}^{l}$$

is a number of neurons in a [symbol] ^{th} layer; N₀ is a number of neurons in an output layer; Nᵢ is a number of neurons in the input layer; M is a number of samples; α is an arbitrary variable, l≤L−1.

Step 2.2.4: systematically constructing an intermediate layer model.

Starting with the geomechanical characterization parameters of the rockburst mining face, after a linear transformation, processing is performed through an activation function to obtain new data of a next layer, layer-to-layer transmission is performed in this manner, and finally the key parameters for the selection of the rockburst-prevention hydraulic supports for the rockburst roadways are reflected, as shown in the following formula:

$${W}^{l} = [ \begin{matrix}{w}_{11}^{l} & … & {W}_{1 {N}_{h}^{l}}^{l} \\ ⋮ & ⋱ & ⋮ \\ {W}_{{N}_{h}^{l - 1} 1}^{l} & … & {W}_{{N}_{h}^{l - 1} {N}_{h}^{l}}^{l}\end{matrix} ] , {z}_{m}^{l} = f ( {W}^{l} \cdot {a}_{m}^{( l - 1 )} + {b}^{l} ) = [ {z}_{{}_{{m}_{1}}}^{{}_{{}_{{}_{l}}}} … {z}_{{}_{{m}_{{N}_{h}^{l}}}}^{{}_{{}_{{}_{l}}}} ] , and \\ {a}_{{}_{m}}^{{}_{{}_{{}_{l}}}} = tanh ( {z}_{{}_{m}}^{{}_{{}_{{}_{l}}}} ) = \frac{{e}^{{z}_{{}_{m}}^{{}_{{}_{{}_{l}}}}} - {e}^{- {z}_{{}_{m}}^{{}_{{}_{{}_{l}}}}}}{{e}^{{z}_{{}_{m}}^{{}_{{}_{{}_{l}}}}} + {e}^{{z}_{{}_{m}}^{{}_{{}_{{}_{l}}}}}} .$$

Where, [symbol] represents a weight matrix of the [symbol] ^{th} layer of the neural network model; [symbol] represents a bias vector of the [symbol] ^{th} layer of the neural network model;

$${a}_{m}^{( l - 1 )}$$

represents an output result of the m^{th} training sample passing through a ( [symbol] −1)^{th} layer of the neural network model;

$${z}_{m}^{l}$$

represents a result obtained after the linear transformation of the m^{th} training sample in the ( [symbol] −1)^{th} layer of the neural network model;

$${z}_{{}_{{m}_{{N}_{h}^{l}}}}^{{}_{{}_{{}_{l}}}}$$

is a

$${( {N}_{h}^{l} )}^{t h}$$

component in

$${z}_{m}^{l} ; {a}_{m}^{l}$$

represents a result obtained by performing a transformation on

$${z}_{m}^{l}$$

by the activation function.

Step 2.2.5: setting configuration of the output layer of the neural network model.

By using the key parameters for the selection of the rockburst-prevention hydraulic supports in the rockburst roadways as the output layer, the initial support force, the working resistance, and the support intensity of the rockburst-prevention hydraulic supports are predicted, and calculation of the output layer is represented by the following formula:

$${z}_{m}^{L} = f ( {W}^{l} \cdot {a}_{m}^{( L - 1 )} + {b}^{L} ) = {[ \begin{matrix}{z}_{{m}_{1}}^{L} & {z}_{{m}_{2}}^{L} & {z}_{{m}_{3}}^{L}\end{matrix} ]}^{T} .$$

A ReLU activation function is used to acquire predicted values of the key parameters for the selection of the rockburst-prevention hydraulic supports in the rockburst roadways, with a specific formula as follows:

$${F}_{c m} = ReLU ( {z}_{{m}_{1}}^{l} ) = \{ \begin{matrix}{z}_{{m}_{1}}^{l} , {z}_{{m}_{1}}^{l} \geq 0 \\ 0 , {z}_{{m}_{1}}^{l} \leq 0\end{matrix} \} ,$$

$${R}_{w m} = R e L U ( {z}_{{m}_{2}}^{l} ) = \{ \begin{matrix}{z}_{{m}_{2}}^{l} , {z}_{{m}_{2}}^{l} \geq 0 \\ 0 , {z}_{{m}_{2}}^{l} \leq 0\end{matrix} \} ,$$

$$and$$

$${S}_{m} = R e L U ( {z}_{{m}_{1}}^{l} ) = \{ \begin{matrix}{z}_{{m}_{1}}^{l} , {z}_{{m}_{1}}^{l} \geq 0 \\ 0 , {z}_{{m}_{1}}^{l} \leq 0\end{matrix} \} .$$

Where F_{cm}, R_{wm} and Sₘ represent predicted key parameter values for the selection of the rockburst-prevention hydraulic supports in the rockburst roadways, namely the initial support force, the working resistance and the support intensity of the rockburst-prevention hydraulic supports.

Step 3: optimizing parameter configuration of the neural network model.

Step 3.1: calculating a value of a loss function.

A mean squared error is selected as the loss function, with a calculation formula as follows:

$$Loss = \frac{1}{2 M} {\sum }_{m = 1}^{M} {( {z}_{m}^{L} - {Z}_{m} )}^{2} ,$$

$$and$$

$${Z}_{m} = [ {F}_{C} , {R}_{w} , S ] .$$

Where Loss is the loss function, and Zₘ is an actual value matrix.

Step 3.2: calculating gradients.

Gradient calculation of the loss function is performed with respect to a weight matrix and a bias vector;

$$\frac{\partial Loss}{\partial {W}^{l}} = \frac{1}{M} {\sum }_{m = 1}^{M} ( {z}_{m}^{L} - {Z}_{m} ) * {X}_{m}^{T} ,$$

$$and$$

$$\frac{\partial Loss}{\partial {b}^{l}} = \frac{1}{M} {\sum }_{m = 1}^{M} ( {z}_{m}^{L} - {Z}_{m} ) .$$

$$Where$$

$$\frac{\partial L}{\partial {W}^{l}}$$

represents a gradient of the loss function Loss with respect to the weight matrix [symbol] of a [symbol] ^{th} layer of the neural network model, and

$$\frac{\partial L}{\partial {b}^{l}}$$

represents a gradient of the loss function Loss with respect to the bias vector [symbol] of the [symbol] ^{th} layer of the neural network model.

Step 3.3: iteratively optimizing parameters of the neural network model.

The weight matrix and the bias vector are updated, with a calculation formula as follows:

$${W}_{t + 1}^{l} = {W}_{t}^{l} - β \frac{\partial Loss}{\partial {W}^{l}} ,$$

$$and$$

$${b}_{t + 1}^{l} = {b}_{t}^{l} - β \frac{\partial Loss}{\partial {b}^{l}} .$$

Where t represents a number of iterations, β represents a correction coefficient for controlling a step size in a process of updating the weight matrix [symbol] of the [symbol] ^{th} layer of the neural network model and the bias vector [symbol] of the [symbol] ^{th} layer of the neural network model.

The weight matrix and the bias vector are repeatedly updated, and updating is performed as per t=t+1 until an iteration stopping condition is:

$${‖ {W}_{t + 1}^{l} - {W}_{t}^{l} ‖}_{∞} < {ε}_{1} ,$$

$$and$$

$${‖ {b}_{t + 1}^{l} - {b}_{t}^{l} ‖}_{∞} < {ε}_{2} .$$

$$Where$$

$$‖ {W}_{t + 1}^{l} - {W}_{t}^{l} {‖}_{∞}$$

represents an infinity norm of

$${W}_{t + 1}^{l} - {W}_{t}^{l} ; {‖ {b}_{t + 1}^{l} - {b}_{t}^{l} ‖}_{∞}$$

represents an infinity norm of

$${b}_{t + 1}^{l} - {b}_{t}^{l} ;$$

and ε₁ and ε₂ represent set thresholds.

Step 4: achieving intelligent selection of the rockburst-prevention hydraulic supports according to a mapping relationship obtained by training the known geomechanical characterization parameters of the rockburst mining face in Step 2-Step 3.

Step 4.1: performing real-time data collection.

By means of a dynamic data monitoring system, the geomechanical characterization parameters of the rockburst mining face in Table 1.1 are collected in real time, which are represented with a symbol:

$$( {σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0} ) .$$

Wherein a superscript 0 in

$${σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0}$$

is represented as the geomechanical characterization parameters of the mining roadways in the corresponding rockburst face, which are collected in real time.

Step 4.2: predicting performance of the rockburst-prevention hydraulic supports by using the neural network model.

The data collected in Step 4.1 is inputted into the neural network model trained in Step 3, the trained neural network model outputs predicted key parameters

$${Z}_{m}^{P} = [ \begin{matrix}{F}_{Cm}^{0} & {R}_{wm}^{0} & {S}_{m}^{0}\end{matrix} ]$$

for the selection of the rockburst-prevention hydraulic supports in the rockburst roadways, and output values

$${F}_{Cm}^{0} , {R}_{wm}^{0} , {S}_{m}^{0}$$

are used for guiding intelligent selection of the rockburst-prevention hydraulic supports.

Beneficial effects adopting the above technical solution lie in that:

The present invention provides the big data intelligent selection design method for rockburst-prevention hydraulic supports in rockburst roadways. Through in-depth analysis of a large amount of geological data, mine face conditions, and historical rockburst-prevention hydraulic support usage, the most suitable rockburst-prevention hydraulic support selection suggestion is provided for roadways. Firstly, data on geological conditions, rock mechanical properties, mine face layout, as well as usage performance and maintenance records of previous rockburst-prevention hydraulic supports is collected from different mining areas and historical records. Then, a machine learning method and a statistical analysis method are used to identify key factors affecting the performance of the rockburst-prevention hydraulic hydraulic supports from an integrated dataset, thereby providing an intelligent rockburst-prevention hydraulic support selection system. The present invention can improve the selection accuracy and efficiency of the rockburst-prevention hydraulic supports and ensure safety.

### BRIEF DESCRIPTION OF DRAWINGS

FIG. 1 is an overall flowchart of an intelligent selection design method for rockburst-prevention hydraulic supports in rockburst roadways according to an embodiment of the present invention; and

FIG. 2 is a diagram of a neural network model according to an embodiment of the present invention.

### DETAILED DESCRIPTION OF THE PREFERRED EMBODIMENT

The specific implementation of the present invention is further described in detail below with reference to the accompanying drawings and embodiments. The following embodiments are used to illustrate the present invention but are not intended to limit the scope thereof.

The embodiment is directed to a 1206 face of a certain mine, a uniaxial compressive strength of coal rocks of the 1206 face is σ_{c}=3.09 MPa, a bursting tendency index of the coal rocks is K=2.196, an elastic modulus of the coal rocks is E=15.7 GPa, an internal friction angle is φ=30°, a mean in-situ stress is P₀=27.01 MPa, a mining depth is h₀=752.5 m, a historical record of rockburst occurrences in coal seams at the same level is n=0, a pressure relief degree of a protective seam is general (the pressure relief degree of the protective seam includes “Good, Medium, General, Very Poor”, and P₁ values under these four conditions are set as 0, 1, 2 and 3). For P₁=2 in the present embodiment, a horizontal distance from a coal pillar remained by mining an upper protective seam is h₁=60 m, a face length is L₀=150 m, a width of a sectional coal pillar is B=25 m, a thickness of coal remained by mining is T=800 mm, a roadway excavated towards a goaf, namely a distance between an excavating stopping position and the goaf is h₂=50 m, and a face advancing towards the goaf, namely a distance between a mining stopping line and the goaf is h₃=40 m;

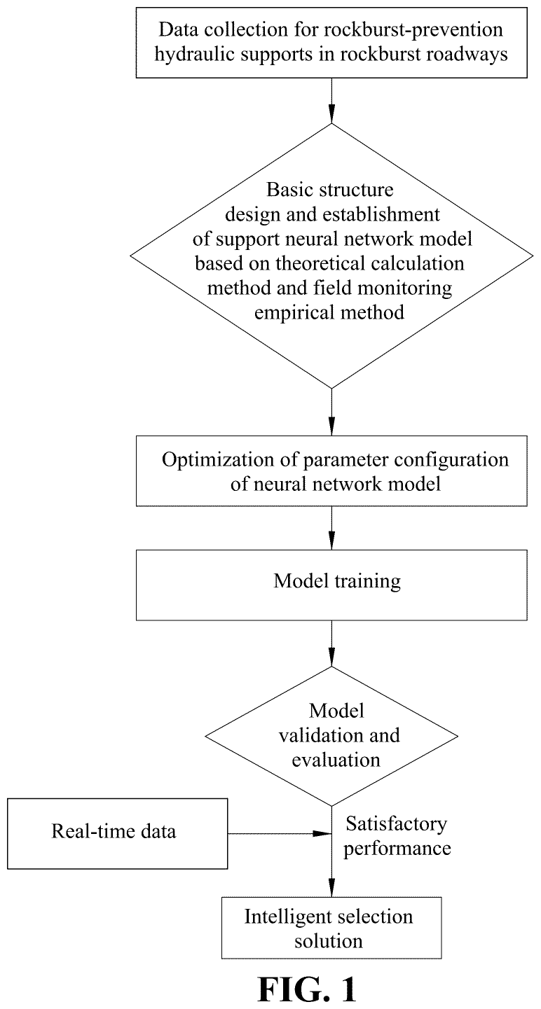

A big data intelligent selection design method for rockburst-prevention hydraulic supports in rockburst roadways, as shown in FIG. 1, includes the following steps.

Step 1: data collection is performed.

Step 1.1: a table of geomechanical characterization parameters of the rockburst mining face is established.

| | S/N | Name of parameters | Symbol | Specific definition of parameters |
|---|---|---|---|---|
| Geological | 1 | Uniaxial compressive | σ_{c}(MPa) | Load per unit area borne by a coal |
| factor | | strength of coal rocks | | sample when being destroyed by an |
| | | | | axial force |
| | 2 | Bursting tendency | K | The property of a coal mass to |
| | | index of coal rocks | | accumulate deformation energy and |
| | | | | generate rockburst failure |
| | 3 | Elastic modulus of | E(GPa) | Reflect the deformation and failure |
| | | coal rocks | | capacity of the coal rocks under an |
| | | | | external force |
| | 4 | Internal friction angle | φ(°) | Reflect the magnitude of internal |
| | | | | friction between particles inside soil |
| | | | | or rocks |
| | 5 | Mean in-situ stress | P₀(MPa) | The mean value of stress within a |
| | | | | specific region of the Earth's crust |
| | 6 | Mining depth | h₀(m) | Vertical depth of coal mining |
| | 7 | Historical record of | n | Statistics on the number of rockburst |
| | | rockburst occurrences | | occurrences at the same level inside |
| | | in coal seams at the | | roadways |
| | | same level | | |
| Mining | 8 | Pressure relief degree | P₁ | Pressure relief degree of the |
| technology | | of a protective seam | | protective seam is one of key |
| factors | | | | indicators for evaluating the mining |
| | | | | effect of the protective seam |
| | 9 | Horizontal distance | h₁(m) | Critical factor affecting rockburst |
| | | from a coal pillar | | risks; the closer the horizontal |
| | | remained by mining an | | distance is, the higher the rockburst |
| | | upper protective seam | | risks are |
| | 10 | Face length | L₀(m) | Face length directly impacts coal |
| | | | | mining efficiency and safety |
| | | | | production of coal mine |
| | 11 | Width of a sectional | B(m) | Non-mined zones reserved for safety |
| | | coal pillar | | and resource conservation in coal |
| | | | | mining |
| | 12 | Thickness of coal | T(mm) | Intentionally retained coal seams with |
| | | remained by mining | | a certain thickness to protect roadway |
| | | | | floor during coal mining |
| | 13 | For roadways | h₂(m) | For roadways excavated towards the |
| | | excavated towards the | | goaf, a safe distance must be |
| | | goaf, the distance | | maintained between the excavating |
| | | between the excavating | | stopping position and the goaf |
| | | stopping position and | | |
| | | the goaf | | |
| | 14 | For the face advancing | h₃(m) | During coal mining, when the |
| | | towards the goaf, the | | advancement direction of the face |
| | | distance between a | | approaches an existing goaf, |
| | | mining stopping line | | determining the position of a |
| | | and the goaf | | reasonable mining stopping line |
| | | | | becomes particularly critical |

Step 1.2: a table of key parameters for selection of rockburst-prevention hydraulic supports in the rockburst roadways is established.

| S/ | Name of | | |
|---|---|---|---|
| N | parameters | Symbol | Specific definition of parameters |
| 1 | Initial | F_{c}(10⁶N) | Force applied by the rockburst-prevention |
| | support | | hydraulic supports upon first contact with |
| | force | | a roof |
| 2 | Working | R_{w}(10⁶N) | Maximum support force applied by the |
| | resistance | | rockburst-prevention hydraulic supports |
| | | | when bearing pressure of the roof |
| 3 | Support | S(MPa) | Support capacity capable of being provided |
| | intensity | | by the rockburst-prevention hydraulic |
| | | | supports per unit area |

Step 1.3: the data is collected.

Based on literature research via the Internet and field investigation analysis, M sets of information on the geomechanical characterization parameters of the rockburst mining face, as well as information on the key parameters of the rockburst-prevention hydraulic supports in the rockburst roadways are collected and analyzed.

In the embodiment, field investigations and literature reviews are conducted to collect 200 sets of data σ_{c}, K, E, φ, P₀, h₀, n, P₁, h₁, L₀, B, T, h₂, h₃ of geomechanical characterization parameters of the rockburst mining face, along with data F_{c}, R_{w},S of key parameters for selection of the rockburst-prevention hydraulic supports in the rockburst roadways, and a sample matrix is constructed. Samples are divided into three sets: a training set, a validation set, and a testing set, with the number of the samples being 160 sets, 40 sets and 40 sets, respectively, and the training set and the validation set are normalized.

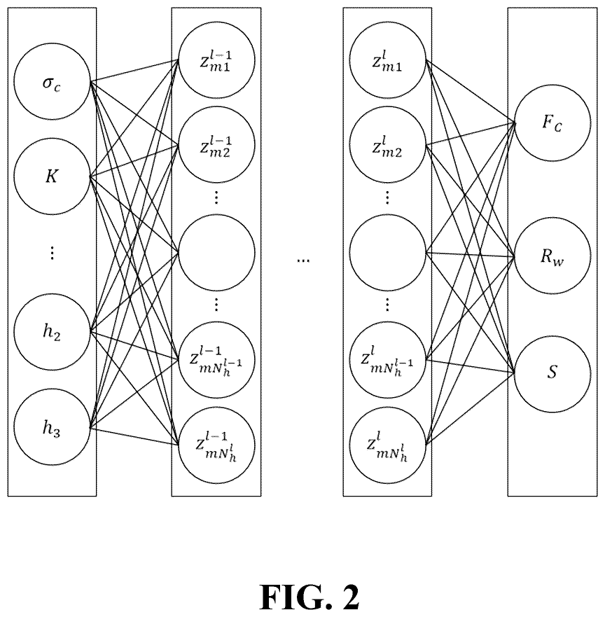

Step 2: based on a neural network model, as shown in FIG. 2, a training sample for intelligent selection of the rockburst-prevention hydraulic supports is established.

Step 2.1: the neural network model suitable for selection of the rockburst-prevention hydraulic supports is selected, wherein the neural network model selects an MLP neural network model.

Step 2.2: a basic structure of the neural network model is defined.

Step 2.2.1: an input layer and a size thereof are determined.

Calculation is performed by using the geomechanical characterization parameters of the rockburst mining face as the input layer of the neural network model, expressed as:

$${X}_{m} = [ {σ}_{c} , K , E , φ , {P}_{0} , {h}_{0} , n , {P}_{1} , {h}_{1} , {L}_{0} , B , T , {h}_{2} , {h}_{3} ] ,$$

$$and$$

$${a}_{m}^{0} = {X}_{m} .$$

$$Where ,$$

$${a}_{m}^{0}$$

represents the input layer of a m^{th} training sample of the neural network model; Xₘ represents a feature vector of the m^{th} training sample.

Step 2.2.2: a number of intermediate layers is determined.

It is set that L layers in total exist in the neural network model, thus L−1 intermediate layers exist. In the embodiment, based on factors such as the type and quantity of the data, it is set that 4 layers in total of the neural network model exist, thus 3 intermediate layers exist.

Step 2.2.3: a number of neurons in each layer is determined.

According to the “empirical formula” provided on the basis of stackoverflow, it can be obtained:

$${N}_{h}^{l} = \frac{M}{( a * ( {N}_{i} + {N}_{o} ) )} .$$

Where Nₕ^{l} is a number of neurons in a [symbol] th layer; Nₒ is a number of neurons in an output layer; Nᵢ is a number of neurons in the input layer; M is a number of samples; and α is an arbitrary variable obtained independently, generally 2-10, l≤L−1. In the embodiment, the value of α is taken as 4, yielding the number of the neurons in each layer being

$${N}_{h}^{l} = \frac{200}{( 4 * ( 14 + 3 ) )} \approx 3 .$$

Step 2.2.4: an intermediate layer model is systematically constructed.

In the neural network model, the core of a forward propagation process of information lies in continuous transformation between layers. According to the technical solution, starting with the geomechanical characterization parameters of the rockburst mining face, after a linear transformation, processing is performed through an activation function to obtain new data of a next layer, layer-to-layer transmission is performed in this manner, and finally the key parameters for the selection of the rockburst-prevention hydraulic supports in the rockburst roadways are reflected, as shown in the following formula:

$${W}^{l} = [ \begin{matrix}{w}_{11}^{l} & ⋯ & {W}_{1 {N}_{h}^{l}}^{l} \\ ⋮ & ⋱ & ⋮ \\ {W}_{{N}_{h}^{l - 1} 1}^{l} & ⋯ & {W}_{{N}_{h}^{l - 1} {N}_{h}^{l}}^{l}\end{matrix} ] ,$$

$${z}_{m}^{l} = f ( {W}^{l} \cdot {a}_{m}^{( l - 1 )} + {b}^{l} ) = [ \begin{matrix}{z}_{{m}_{1}}^{l} & … & {z}_{{m}_{{N}_{h}^{l}}}^{l}\end{matrix} ] ,$$

$$and$$

$${a}_{m}^{l} = tan h ( {z}_{m}^{l} ) = \frac{{e}^{{z}_{m}^{l}} - {e}^{- {z}_{m}^{l}}}{{e}^{{z}_{m}^{l}} + {e}^{- {z}_{m}^{l}}} .$$

Where, [symbol] represents a weight matrix of the [symbol] ^{th} layer of the neural network model; [symbol] represents a bias vector of the [symbol] ^{th} layer of the neural network model;

$${a}_{m}^{( l - 1 )}$$

represents an output result of the m^{th} training sample passing through the ( [symbol] −1)^{th} layer of the neural network model;

$${z}_{m}^{l}$$

represents a result obtained after the linear transformation of the m^{th} training sample in the ( [symbol] −1)^{th} layer of the neural network model;

$${z}_{{m}_{{N}_{h}^{l}}}^{l}$$

is the

$${( {N}_{h}^{l} )}^{th}$$

component in

$${z}_{m}^{l} ; {a}_{m}^{l}$$

represents a result obtained by performing transformation on

$${z}_{m}^{l}$$

by the activation function.

Step 2.2.5: configuration of the output layer of the neural network model is set.

By using the key parameters for the selection of the rockburst-prevention hydraulic supports in the rockburst roadways as the output layer, the initial support force, the working resistance, and the support intensity of the rockburst-prevention hydraulic supports are predicted, and calculation of the output layer is represented by the following formula:

$${z}_{m}^{L} = f ( {W}^{l} \cdot {a}_{m}^{( L - 1 )} + {b}^{L} ) = {[ \begin{matrix}{z}_{{m}_{1}}^{L} & {z}_{{m}_{2}}^{L} & {z}_{{m}_{3}}^{L}\end{matrix} ]}^{T} .$$

A ReLU activation function is used to acquire predicted values of the key parameters for the selection of the rockburst-prevention hydraulic supports in the rockburst roadways, with a specific formula as follows:

$${F}_{cm} = ReLU ( {z}_{{m}_{1}}^{l} ) = \{ \begin{matrix}{z}_{{m}_{1}}^{l} , {z}_{{m}_{1}}^{l} \geq 0 \\ 0 , {z}_{{m}_{1}}^{l} \leq 0\end{matrix} \} ,$$

$${R}_{wm} = ReLU ( {z}_{{m}_{2}}^{l} ) = \{ \begin{matrix}{z}_{{m}_{2}}^{l} , {z}_{{m}_{2}}^{l} \geq 0 \\ 0 , {z}_{{m}_{2}}^{l} \leq 0\end{matrix} \} ,$$

$$and$$

$${S}_{m} = ReLU ( {z}_{{m}_{1}}^{l} ) = \{ \begin{matrix}{z}_{{m}_{1}}^{l} , {z}_{{m}_{1}}^{l} \geq 0 \\ 0 , {z}_{{m}_{1}}^{l} \leq 0\end{matrix} \} .$$

Where F_{cm}, R_{wm} and Sₘ represent predicted key parameter values for the selection of the rockburst-prevention hydraulic supports in the rockburst roadways, namely the initial support force, the working resistance and the support intensity of the rockburst-prevention hydraulic supports.

Step 3: parameter configuration of the neural network model is optimized.

Step 3.1: a value of a loss function is calculated.

A mean squared error is selected as the loss function, with a calculation formula as follows:

$$Loss = \frac{1}{2 M} {\sum }_{m = 1}^{M} {( {z}_{m}^{L} - {Z}_{m} )}^{2} ,$$

$$and$$

$${Z}_{m} = [ {F}_{C} , {R}_{w} , S ] .$$

Where Loss is the loss function, and Zₘ is an actual value matrix.

Step 3.2: gradients are calculated.

Gradient calculation of the loss function is performed with respect to a weight matrix and a bias vector:

$$\frac{\partial Loss}{\partial {W}^{l}} = \frac{1}{M} {\sum }_{m = 1}^{M} ( {z}_{m}^{L} - {Z}_{m} ) * {X}_{m}^{T} ,$$

$$and$$

$$\frac{\partial Loss}{\partial {b}^{l}} = \frac{1}{M} {\sum }_{m = 1}^{M} ( {z}_{m}^{L} - {Z}_{m} ) .$$

$$Where \frac{\partial L}{\partial {W}^{l}}$$

represents a gradient of the loss function Loss with respect to the weight matrix [symbol] of a [symbol] ^{th} layer of the neural network model, and

$$\frac{\partial L}{\partial {b}^{l}}$$

represents a gradient of the loss function Loss with respect to the bias vector [symbol] of the [symbol] ^{th} layer of the neural network model.

Step 3.3: parameters of the neural network model are iteratively optimized.

The weight matrix and the bias vector are updated, with a calculation formula as follows:

$${W}_{t + 1}^{l} = {W}_{t}^{l} - β \frac{\partial Loss}{\partial {W}^{l}} ,$$

$$and$$

$${b}_{t + 1}^{l} = {b}_{t}^{l} - β \frac{\partial Loss}{\partial {b}^{l}} .$$

Where t represents a number of iterations, β represents a correction coefficient for controlling a step size in a process of updating the weight matrix [symbol] of the [symbol] ^{th} layer of the neural network model and the bias vector [symbol] of the [symbol] ^{th} layer of the neural network model; in the embodiment, the number of iterations is t=100.

The weight matrix and the bias vector are repeatedly updated, and updating is performed as per t=t+1 until an iteration stopping condition is:

$${‖ {W}_{t + 1}^{l} - {W}_{t}^{l} ‖}_{∞} < {ε}_{1} ,$$

$$and$$

$${‖ {b}_{t + 1}^{l} - {b}_{t}^{l} ‖}_{∞} < {ε}_{2} .$$

$$Where {‖ {W}_{t + 1}^{l} - {W}_{t}^{l} ‖}_{∞}$$

represents an infinity norm of

$${W}_{t + 1}^{l} - {W}_{t}^{l} ; {‖ {b}_{t + 1}^{l} - {b}_{t}^{l} ‖}_{∞}$$

represents an infinity norm of

$${b}_{t + 1}^{l} - {b}_{t}^{l} ;$$

and ε₁ and ε₂ represent set thresholds.

Step 4: intelligent selection of the rockburst-prevention hydraulic supports is achieved according to a mapping relationship obtained by training known geomechanical characterization parameters of the rockburst mining face in Step 2-Step 3.

Step 4.1: real-time data collection is performed.

By means of a dynamic data monitoring system, the geomechanical characterization parameters of the rockburst mining face in Table 1.1 are collected in real time, which are represented with a symbol:

$$( {σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0} ) .$$

Wherein a superscript 0 in

$${σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0}$$

is represented as the geomechanical characterization parameters of the mining roadways in the corresponding rockburst face, which are collected in real time.

In the embodiment, the uniaxial compressive strength of the coal rocks, the bursting tendency index of the coal rocks, the elastic modulus of the coal rocks, and the internal friction angle are obtained through indoor testing using testing machines; the pressure relief degree of the protective seam is acquired using existing stress gauges; and the mean in-situ stress is obtained by a stress contact method and a ground stress testing method, with mining depth recorded by drawings. The historical record of rockburst occurrences of the coal seams at the same level, i.e., log information of rockburst manifestations, the pressure relief degree of the protective seam, the horizontal distance from a coal pillar remained by mining an upper protective seam, the face length, the width of a sectional coal pillar, the thickness of coal remained by mining, a roadway excavated towards a goaf, namely a distance between an excavating stopping position and the goaf, and a face advancing towards the goaf, namely a distance between a mining stopping line and the goaf can be obtained by measurement according to a mining engineering plane view.

Step 4.2: performance prediction is performed on the rockburst-prevention hydraulic supports by using the neural network model.

The data collected in Step 4.1 is inputted into the neural network model trained in Step 3, the trained neural network model outputs predicted key parameters

$${Z}_{m}^{P} = [ \begin{matrix}{F}_{Cm}^{0} & {R}_{w m}^{0} & {S}_{m}^{0}\end{matrix} ]$$

for the selection of the rockburst-prevention hydraulic supports in the rockburst roadways, and output values

$${F}_{Cm}^{0} , {R}_{w m}^{0} , {S}_{m}^{0}$$

are used for guiding intelligent selection of the rockburst-prevention hydraulic supports.

The data from the embodiment is used, the data from the dataset is shown in a tabular form and specific values involved in the above process are given.

| σ_{c} | K | E | φ | P₀ | h₀ | n | P₁ | h₁ | L₀ | B | T | h₂ | h₃ |
|---|---|---|---|---|---|---|---|---|---|---|---|---|---|
| 3.09 | 2.196 | 15.7 | 30 | 27.01 | 752.5 | 0 | 2 | 60 | 150 | 25 | 800 | 50 | 40 |
| 3.15 | 2.25 | 16.0 | 29 | 28.00 | 755.0 | 1 | 1 | 65 | 145 | 30 | 850 | 45 | 35 |
| 2.95 | 2.05 | 15.5 | 31 | 26.50 | 740.0 | 0 | 2 | 55 | 155 | 20 | 780 | 55 | 45 |

The specific values involved in the above process are as follows.

The number of the neurons in each layer is

$${N}_{h}^{l} = 3 :$$

the number of the layers is L=4; the number of iterations is t=100; and the threshold is e₁=e₂=1*10⁻³.

Weights for each layer:

$${W}^{1} \qquad = [ \begin{matrix}− 0.2882 & − 0.0245 & 0.2791 \\ 0.0478 & − 0.0925 & − 0.4163 \\ 0.116 & − 0.1045 & 0.0105 \\ − 0.168 & − 0.0863 & 0.0804 \\ − 0.5908 & − 0.6684 & − 0.4902 \\ − 0.4796 & − 0.0658 & − 0.0274 \\ − 0.6818 & − 0.1506 & 0.0098 \\ − 0.0458 & 0.1469 & − 0.4147 \\ 0.1023 & − 0.2333 & 0.3051 \\ − 0.4435 & − 0.3415 & − 0.7092 \\ 0.0642 & 0.0373 & − 0.1281 \\ 0.2851 & − 0.8076 & − 0.7327 \\ − 0.5474 & 0.0134 & 0.1724 \\ − 0.1222 & 0.2794 & − 0.7932\end{matrix} ] ,$$

$${W}^{2} \qquad = [ \begin{matrix}0.9478 & 0.7296 & − 0.4761 \\ − 0.2005 & 0.0656 & − 0.8915 \\ 0.609 & − 0.1319 & − 0.7174\end{matrix} ] ,$$

$${W}^{3} = [ \begin{matrix}− 0.921 & − 0.6255 & − 0.1892 \\ − 0.5772 & − 0.0501 & − 0.2909 \\ 1.2371 & 1.0465 & − 1.5564\end{matrix} ] ,$$

$$and$$

$${W}^{4} = [ \begin{matrix}1.4197 & 1.6501 & 1.1216 \\ 1.5916 & 0.6 & 0.5372 \\ − 1.3698 & − 0.0435 & 0.72\end{matrix} ] .$$

Bias vectors for each layer:

$${b}^{1} = [ \begin{matrix}- 0.1 \; 649 & \begin{matrix}- 0.2819 & - 0.2472\end{matrix}\end{matrix} ] ,$$

$${b}^{2} = [ \begin{matrix}- 0.2 \; 326 & \begin{matrix}0.0803 & 0.3128\end{matrix}\end{matrix} ] ,$$

$${b}^{3} = [ \begin{matrix}0.284 & \begin{matrix}0.3948 & - 0.4565\end{matrix}\end{matrix} ] ,$$

$$and$$

$${b}^{4} = [ \begin{matrix}0.7036 & 0.6204 & 0.2743 ] .\end{matrix}$$

No. 1 real-time data

$${σ}_{c}^{1} = 3.09 , {K}^{1} = 2.196 , {E}^{1} = 15 \text{.7} , {φ}^{1} = 30 , {P}_{0}^{1} = 27.01 , {h}_{0}^{1} = 752.5 , {n}^{1} = 0 , {P}_{1}^{1} = 2 , {h}_{1}^{1} = 60 , {L}_{0}^{1} = 150 , {B}^{1} = 25 , {T}^{1} = 800 , {h}_{2}^{1} = 50 , {h}_{3}^{1} = 40$$

is taken as an example, and the prediction results are:

$${Z}_{m 1}^{P} = [ \begin{matrix}\begin{matrix}{F}_{Cm 1}^{0} & {R}_{wm 1}^{0}\end{matrix} & {S}_{m 1}^{0}\end{matrix} ] = [ \begin{matrix}\begin{matrix}4.91 & 2.859\end{matrix} & 1.217 ] .\end{matrix}$$

No. 2 real-time data

$${σ}_{c}^{2} = 3.15 , {K}^{2} = 2.25 , {E}^{2} = 16 \text{.0} , {φ}^{2} = 29 , {P}_{0}^{2} = 28. , {h}_{0}^{2} = 755.0 , {n}^{2} = 1 , {P}_{1}^{2} = 1 , {h}_{1}^{2} = 65 , {L}_{0}^{2} = 145 , {B}^{2} = 30 , {T}^{2} = 850 , {h}_{2}^{2} = 45 , {h}_{3}^{2} = 35$$

is taken as an example, and the prediction results are:

$${Z}_{m}^{P} = [ \begin{matrix}{F}_{Cm 2}^{0} & {R}_{wm 2}^{0} & {S}_{m 2}^{0}\end{matrix} ] = [ \begin{matrix}4.756 & 3.144 & 1.235 ] .\end{matrix}$$

No. 3 real-time data

$${σ}_{c}^{3} = 2.95 , {K}^{3} = 2.05 , {E}^{3} = 15 \text{.5} , {φ}^{3} = 31 , {P}_{0}^{3} = 26.5 , {h}_{0}^{3} = 740.0 , {n}^{3} = 0 , {P}_{1}^{3} = 2 , {h}_{1}^{3} = 55 , {L}_{0}^{3} = 155 , {B}^{3} = 20 , {T}^{3} = 780 , {h}_{2}^{3} = 55 , {h}_{3}^{3} = 45$$

is taken as an example, and the prediction results are:

$${Z}_{m 3}^{P} = [ \begin{matrix}{F}_{Cm 2}^{0} & {R}_{wm 2}^{0} & {S}_{m 3}^{0}\end{matrix} ] = [ \begin{matrix}4.939 & 2.917 & 1.188 ] .\end{matrix}$$

The key parameters for the selection of the rockburst-prevention hydraulic supports in the rockburst roadways are predicted.

No. 1 real-time data prediction: initial support force

$${F}_{Cm 1}^{0} = 4 \; 910 kN ,$$

working resistance

$${R}_{w m 1}^{0} = 2859 kN ,$$

and support intensity

$${S}_{m 1}^{0} = 1.2 \; 17 MPa .$$

No. 2 real-time data prediction: initial support force

$${F}_{C m 2}^{0} = 4756 kN ,$$

working resistance

$${R}_{w m 2}^{0} = 3114 kN ,$$

and support intensity

$${S}_{m 2}^{0} = 1.2 \; 35 MPa .$$

No. 3 real-time data prediction: initial support force

$${F}_{C m 3}^{0} = 4939 kN ,$$

working resistance

$${R}_{w m 3}^{0} = 2917 kN ,$$

and support intensity

$${S}_{m 3}^{0} = 1.1 \; 88 MPa .$$

The foregoing description merely represents preferred embodiments of the present invention and explains the technical principles applied. Those skilled in the art should understand that the scope of the present invention involved in the embodiments of the present invention is not limited to the technical solutions formed by specific combinations of the above technical features, but shall also cover other technical solutions formed by any combination of the above technical features or their equivalent features without departing from the concept of the present invention. For example, technical solutions formed by interchanging the aforementioned features with technical features having similar functions (including but not limited to those disclosed in the embodiments of the present invention) shall fall within the scope of the present invention.

1. A big data intelligent selection design method for rockburst-prevention hydraulic supports in rockburst roadways, comprising the following steps:
Step 1: performing data collection;
Step 2: based on a neural network model, establishing a training sample for intelligent selection of the rockburst-prevention hydraulic supports;
Step 2.1: selecting the neural network model suitable for selection of the rockburst-prevention hydraulic supports, wherein the neural network model selects an MLP neural network model; and
Step 2.2: defining a basic structure of the neural network model;
Step 2.2.1: determining an input layer and a size thereof, wherein
calculation is performed by using the geomechanical characterization parameters of the rockburst mining face as the input layer of the neural network model, expressed as:
$${X}_{m} = [ {σ}_{c} , K , E , φ , {P}_{0} , {h}_{0} , n , {P}_{1} , {h}_{1} , {L}_{0} , B , T , {h}_{2} , {h}_{3} ] \\ and \\ {a}_{m}^{0} = {X}_{m} ,$$
wherein
$${a}_{m}^{0}$$
represents the input layer of a m^{th} training sample of the neural network model; Xₘ represents a feature vector of the m^{th} training sample;
Step 2.2.2: determining a number of intermediate layers, wherein
it is set that L layers in total exist in the neural network model, thus L−1 intermediate layers exist;
Step 2.2.3: determining a number of neurons in each layer,
$${N}_{h}^{l} = \frac{M}{( α * ( {N}_{i} + {N}_{o} )} ,$$
wherein Nₕ^{l} is a number of neurons in a lth layer; Nₒ is a number of neurons in an output layer; Nᵢ is a number of neurons in the input layer; M is a number of samples; α is an arbitrary variable, l≤L−1;
Step 2.2.4: systematically constructing an intermediate layer model, wherein starting with the geomechanical characterization parameters of the rockburst mining face, after a linear transformation, processing is performed through an activation function to obtain new data of a next layer, a layer-to-layer transmission is performed in this manner, and finally the key parameters for the selection of the rockburst-prevention hydraulic supports for the rockburst roadways are reflected, as shown in the following formula:
$${W}^{l} = [ \begin{matrix}{w}_{11}^{{}_{l}} & … & {W}_{1 {N}_{h}^{l}}^{{}_{l}} \\ ⋮ & ⋱ & ⋮ \\ {W}_{{N}_{h}^{l - 1} 1}^{{}_{l}} & … & {W}_{{N}_{h}^{l - 1} {N}_{h}^{l}}^{{}_{l}}\end{matrix} ] , \\ {z}_{m}^{{}_{l}} = f ( {{W}^{l}}^{} \cdot {a}_{m}^{( l - 1 )} + {{b}^{l}}^{} ) = [ {z}_{{m}_{1}}^{{}_{l}} … {z}_{{m}_{{N}_{h}^{l}}}^{{}_{l}} ] , \\ and \\ {a}_{m}^{l} = tanh ( {z}_{m}^{l} ) = \frac{{e}^{{z}_{m}^{l}} - {e}^{- {z}_{m}^{l}}}{{e}^{{z}_{m}^{l}} + {e}^{- {z}_{m}^{l}}} ,$$
wherein, W^{l} represents a weight matrix of the lth layer of the neural network model; b^{l} represents a bias vector of the lth layer of the neural network model:
$${a}_{m}^{( l - 1 )}$$
represents an output result of the m^{th} training sample passing through a (l−1)th layer of the neural network model:
$${z}_{m}^{l}$$
represents a result obtained after the linear transformation of the m^{th} training sample in the (l−1)th layer of the neural network model:
$${z}_{{m}_{{N}_{h}^{l}}}^{l} is a ( {N}_{h}^{l} )$$
th component in
$${z}_{m}^{l} ; {a}_{m}^{l}$$
represents a result obtained by performing a transformation on zₘ^{l} by the activation function;
Step 2.2.5: setting configuration of the output layer of the neural network model, wherein by using the key parameters for the selection of the rockburst-prevention hydraulic supports in the rockburst roadways as the output layer, the initial support force, the working resistance, and the support intensity of the rockburst-prevention hydraulic supports are predicted, and calculation of the output layer is represented by the following formula:
$${z}_{m}^{L} = f ( {W}^{l} \cdot {a}_{m}^{( L - 1 )} + {b}^{L} ) = {[ \begin{matrix}{z}_{{m}_{1}}^{L} & {z}_{{m}_{2}}^{L} & {z}_{{m}_{3}}^{L}\end{matrix} ]}^{T} ,$$
a ReLU activation function is used to acquire predicted values of the key parameters for the selection of the rockburst-prevention hydraulic supports in the rockburst roadways, with a specific formula as follows:
$${F}_{cm} = ReLU ( {z}_{{m}_{1}}^{L} ) = \{ \begin{matrix}{z}_{{m}_{1}}^{L} , {z}_{{m}_{1}}^{L} \geq 0 \\ 0 , {z}_{{m}_{1}}^{L} \leq 0\end{matrix} \} ,$$
$${R}_{wm} = ReLU ( {z}_{{m}_{2}}^{L} ) = \{ \begin{matrix}{z}_{{m}_{2}}^{L} , {z}_{{m}_{2}}^{L} \geq 0 \\ 0 , {z}_{{m}_{2}}^{L} \leq 0\end{matrix} \} , and$$
$${S}_{m} = ReLU ( {z}_{{m}_{1}}^{L} ) = \{ \begin{matrix}{z}_{{m}_{1}}^{L} , {z}_{{m}_{1}}^{L} \geq 0 \\ 0 , {z}_{{m}_{1}}^{L} \leq 0\end{matrix} \} ,$$
wherein F_{cm}, R_{wm} and Sₘ represent predicted key parameter values for the selection of the rockburst-prevention hydraulic supports in the rockburst roadways, namely the initial support force, the working resistance and the support intensity of the rockburst-prevention hydraulic supports;
Step 3: optimizing parameter configuration of the neural network model; and
Step 4: achieving intelligent selection of the rockburst-prevention hydraulic supports according to a mapping relationship obtained by training known geomechanical characterization parameters of a rockburst mining face in Step 2-Step 3.

2. The big data intelligent selection design method for the rockburst-prevention hydraulic supports in the rockburst roadways of claim 1, wherein Step 1 comprises the following steps:
Step 1.1: establishing a table of the geomechanical characterization parameters of the rockburst mining face, wherein
the geomechanical characterization parameters comprise geological factor data and mining technical factor data, the geological factor data comprises the following data: a uniaxial compressive strength σ_{c} of coal rocks, a bursting tendency index K of the coal rocks, an elastic modulus E of the coal rocks, an internal friction angle φ, a mean in-situ stress P₀, a mining depth h₀, and a historical record n of rockburst occurrences in coal seams at a same level, and the mining technical factor data comprises the following data: a pressure relief degree P₁ of a protective seam, a horizontal distance h₁ from a coal pillar remained by mining the protective seam, a face length L₀, a width B of a sectional coal pillar, a thickness T of coal remained by mining, a roadway excavated towards a goaf, namely a distance h₂ between an excavating stopping position and the goaf, and a face advancing towards the goaf, namely a distance h₃ between a mining stopping line and the goaf;
Step 1.2: establishing a table of key parameters for selection of the rockburst-prevention hydraulic supports in the rockburst roadways, wherein
the key parameters comprise the following data: an initial support force F_{c}, a working resistance R_{w} and a support intensity S; and
Step 1.3: collecting the data, wherein
based on literature research via the Internet and field investigation analysis, M sets of information on the geomechanical characterization parameters of the rockburst mining face, as well as information on the key parameters of the rockburst-prevention hydraulic supports in the rockburst roadways are collected and analyzed.

3. (canceled)

4. (canceled)

5. The big data intelligent selection design method for the rockburst-prevention hydraulic supports in the rockburst roadways of claim 1, wherein Step 3 comprises the following steps:
Step 3.1: calculating a value of a loss function, wherein
a mean squared error is selected as the loss function, with a calculation formula as follows:
$$Loss = \frac{1}{2 M} {\sum }_{m = 1}^{M} {( {z}_{m}^{L} - {Z}_{m} )}^{2} , and$$
$${Z}_{m} = [ {F}_{C} , {R}_{w} , S ] ,$$
wherein Loss is the loss function, and Zₘ is an actual value matrix;
Step 3.2: calculating gradients, wherein
gradient calculation of the loss function is performed with respect to a weight matrix and a bias vector,
$$\frac{\partial Loss}{\partial {W}^{l}} = \frac{1}{M} {\sum }_{m = 1}^{M} ( {z}_{m}^{L} - {Z}_{m} ) * {X}_{m}^{T} , and$$
$$\frac{\partial Loss}{\partial {b}^{l}} = \frac{1}{M} {\sum }_{m = 1}^{M} ( {z}_{m}^{L} - {Z}_{m} ) ,$$
$$wherein \frac{\partial L}{\partial {W}^{l}}$$
represents a gradient of the loss function Loss with respect to the weight matrix [symbol] of a [symbol] layer of the neural network model, and
$$\frac{\partial L}{\partial {b}^{l}}$$
represents a gradient of the loss function Loss with respect to the bias vector [symbol] of the [symbol] layer of the neural network model;
Step 3.3: iteratively optimizing parameters of the neural network model, wherein the weight matrix and the bias vector are updated, with a calculation formula as follows:
$${W}_{t + 1}^{l} = {W}_{t}^{l} - β \frac{\partial Loss}{\partial {W}^{l}} , and$$
$${b}_{t + 1}^{l} = {b}_{t}^{l} - β \frac{\partial Loss}{\partial {b}^{l}} ,$$
wherein t represents a number of iterations, β represents a correction coefficient for controlling a step size in a process of updating the weight matrix [symbol] of the [symbol] ^{th} layer of the neural network model and the bias vector [symbol] of the [symbol] ^{th} layer of the neural network model; and
the weight matrix and the bias vector are repeatedly updated, and updating is performed as per t=t+1 until an iteration stopping condition is:
$${‖ {W}_{t + 1}^{l} - {W}_{t}^{l} ‖}_{∞} < {ε}_{1} , and$$
$${‖ {b}_{t + 1}^{l} - {b}_{t}^{l} ‖}_{∞} < {ε}_{2} ,$$
$$wherein {‖ {W}_{t + 1}^{l} - {W}_{t}^{l} ‖}_{∞}$$
represents an infinity norm of
$${W}_{t + 1}^{l} - {W}_{t}^{l} ; {‖ {b}_{t + 1}^{l} - {b}_{t}^{l} ‖}_{∞}$$
represents an infinity norm of
$${b}_{t + 1}^{l} - {b}_{t}^{l} ;$$
and ε₁ and ε₂ represent set thresholds.

6. The big data intelligent selection design method for the rockburst-prevention hydraulic supports in the rockburst roadways of claim 1, wherein Step 4 comprises the following steps:
Step 4.1: performing real-time data collection, wherein
by means of a dynamic data monitoring system, the geomechanical characterization parameters of the rockburst mining face are collected in real time, which are represented with a symbol:
$$( {σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0} ) ,$$
wherein a superscript 0 in
$${σ}_{c}^{0} , {K}^{0} , {E}^{0} , {φ}^{0} , {P}_{0}^{0} , {h}_{0}^{0} , {n}^{0} , {P}_{1}^{0} , {h}_{1}^{0} , {L}_{0}^{0} , {B}^{0} , {T}^{0} , {h}_{2}^{0} , {h}_{3}^{0}$$
is represented as the geomechanical characterization parameters of the mining roadways in the corresponding rockburst face, which are collected in real time; and
Step 4.2: predicting performance of the rockburst-prevention hydraulic supports by using
the neural network model, wherein
the data collected in Step 4.1 is inputted into the neural network model trained in Step 3, the trained neural network model outputs predicted key parameters
$${Z}_{m}^{p} = [ \begin{matrix}{F}_{Cm}^{0} & {R}_{wm}^{0} & {S}_{m}^{0}\end{matrix} ]$$
for the selection of the rockburst-prevention hydraulic supports in the rockburst roadways, and output values
$${F}_{Cm}^{0} , {R}_{wm}^{0} , {S}_{m}^{0}$$
are used for guiding intelligent selection of the rockburst-prevention hydraulic supports.
